(19) United States
(12) Patent Application Publication
(10) Pub. No.: US 2004/0033819 A1
(43) Pub. Date: Feb. 19, 2004

(54) Personalized audio profile for a subscriber device and method thereof

(75) Inventor: James Allen Hymel, Lake Worth, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/219,124

(22) Filed: Aug. 15, 2002

(51) Int. Cl. H04B 1/38

(52) U.S. Cl. 455/567; 455/551; 455/419

(57) ABSTRACT

A method of providing a personalized audio profile for a user of a subscriber device, the method preferably implemented as a subscriber device and audio processing function therein. The method includes detecting at the subscriber device a profile corresponding to the user; adapting, responsive to the profile, an audio processing function; and providing an audible signal, at the subscriber device, that has been processed according to the profile.

### FIELD OF THE INVENTION

This invention relates in general to communication systems, and more specifically to a method of providing a personalized audio profile for a user of a subscriber device and the subscriber devices operating therein.

### BACKGROUND OF THE INVENTION

Communications systems such as two way and cellular systems suitable for providing voice communications services and the corresponding subscriber devices or devices having voice communications capability for operating therein are known. Such subscriber devices, due to economic pressures have evolved to a “one size fits all” approach where each phone model has identical user output features and characteristics for all users. However users of the devices are not “one size.” This is particularly evident in terms of the aural sense where age, experience, and genetic differences result in a large variation in hearing characteristics and abilities across a population, particularly with respect to signal level and frequency sensitivities.

Typically a subscriber device provides a volume control that allows a user to adjust audible signal levels to account for their respective hearing abilities, background noise and the like. However if another individual picks up that subscriber device or that user picks up another device time can be lost while the volume control is adjusted according to taste and requirements. Clearly a need exists for personalized audio profile methods and apparatus for subscriber devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a communications system and subscriber device suitable for utilizing a personal audio profile according to the present invention;

FIG. 2 depicts a block diagram of a preferred embodiment of a subscriber device with audio processing corresponding to a user profile according to the present invention; and

FIG. 3 illustrates a flow chart of a preferred method embodiment of providing a personalized audio profile according to the present invention.

### DETAILED DESCRIPTION OF PREFERRED EMBODIMENTS

In overview form the present disclosure concerns communications systems that provide services and specifically voice communications services to subscriber devices or units, such as cellular phones or two-way radios and the like, and users thereof operating therein. More particularly various inventive concepts and principles embodied in user interfaces and methods thereof for providing a personalized audio profile or specifically audible signal according to such a profile for the convenience and advantage of users are discussed. The communications systems and messaging devices that are of particular interest are those that provide or facilitate voice communications services, such as conventional two way systems and devices, various cellular phone systems including analog and digital cellular, CDMA (code division multiple access) and variants thereof, GSM, GPRS (General Packet Radio System), and 2.5 G and 3G systems such as UMTS (Universal Mobile Telecommunication Service) systems and future evolutions thereof.

As further discussed below various inventive principles and combinations thereof are advantageously employed to provide a personalized audio profile for a subscriber device that is adaptable and adapted to a particular user and that users capabilities, thus alleviating various problems associated with known static or fixed audio profiles while still facilitating a full range of features and applications for the subscriber device provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

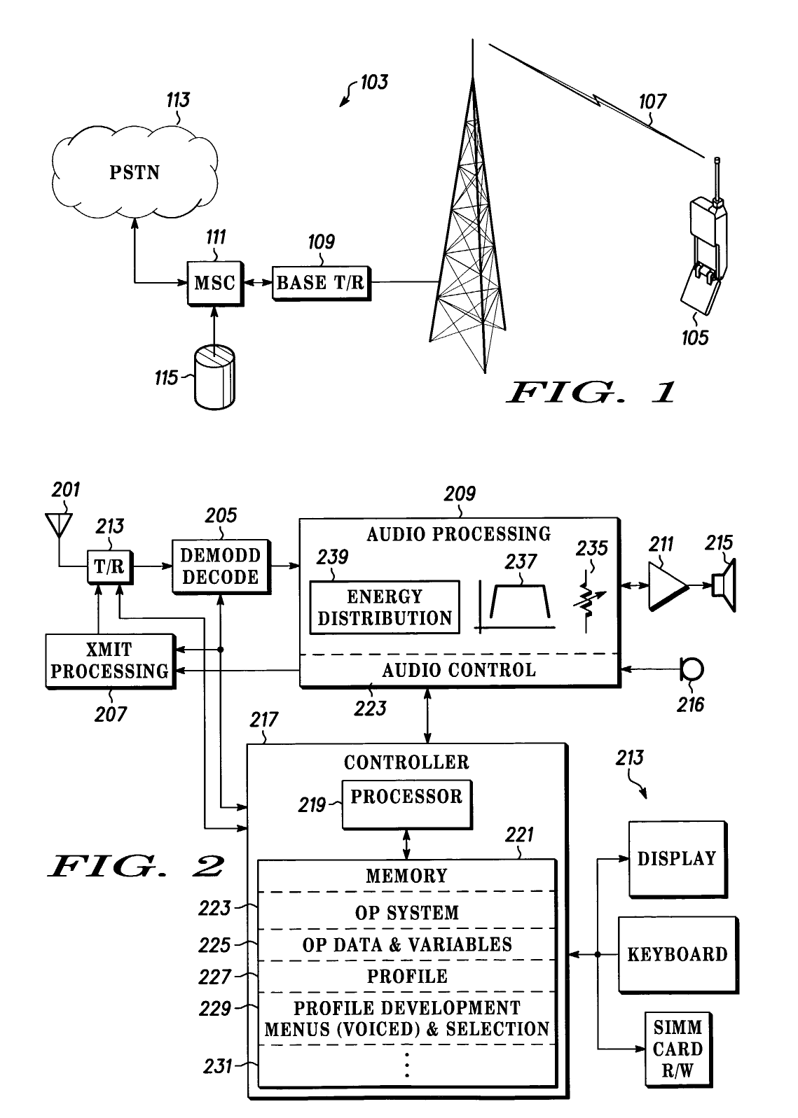

Referring to FIG. 1, a simplified and representative communications system, such as a cellular mobile phone (cellular) system 103 coupled to the PSTN (public switched telephone system or the like) 113 and subscriber device 105, inter-coupled via radio signal 107, suitable for implementing and utilizing a personal audio profile will be discussed and described. The subscriber device 105 is a cellular handset or portable or mobile unit that is arranged and constructed to send and receive messages over the wireless link or radio signal 107 to and from the cellular system 103 as well as convert these signals to and from voice or audible signals for interaction with a user of the subscriber device. The subscriber device 105 is further arranged and constructed to facilitate operation and utilization of the device by providing access to various features and functions as well as maintenance routines for such features and functions. These features and functions include such items as phone books, address books, voice and email folders and the like and as we will discuss in further detail herein below an inventive personalized audio profile that may be developed, maintained, and used to the advantage of and according to the users desires.

The communications system or as here depicted cellular system 103 represents the service provider and includes the known base transceiver 109 coupled to an antenna structure for receiving and transmitting messages via the wireless link or radio wave 107 to subscriber units, such as the subscriber unit 105 depicted. The base transceiver is coupled along with several others not shown to a mobile switching center 111 and from there to the PSTN 111 or other networks such as packet data networks like the Internet, Web, etc. The mobile switching center is for the most part known and handles routing of calls via proper base transceivers, billing and so on.

Here the mobile switching center is depicted with a database 115 such as a magnetic memory or hard drive that includes among other items voiced messages and menus that may be changed or at least changed from a masculine to feminine voice dependent of the personal audio profile and relative compatibility therewith for a particular user.

Referring to FIG. 2 a block diagram of a preferred embodiment of a subscriber device, such as the device 105, with audio processing corresponding to a user profile will be discussed and described. The subscriber device is arranged and constructed to provide personalized audible signals to a user thereof. Note that the specific functionality of the subscriber unit or blocks thereof will depend on the particular access technology and other conventions used by the service provider. These specifics of transmission and reception and relevant processing are known and not here further relevant so any further discussions will be in generalities that are generally applicable to most if not all systems. The subscriber device includes an antenna 201 that operates to radiate and absorb radio frequency signals that are transmitted or sent from or received by a transceiver 203 as is known. The transceiver 203 or receiver portion thereof provides a base band signal that is coupled to a known demodulator/decoder 205. The transceiver or transmitter portion is also coupled to a transmit processing function 207 that operates to encode/modulate and so on, as known, to prepare uplink signals for amplification and transmission. The demodulator/decoder provides signals corresponding to an audible signal for a user to an audio processor or audio processing function 209. The audio processor 209 feeds an amplifier 211 and this is coupled to a transducer 215, such as an earpiece or speaker that is one element of a user input output 213. Other items in the user input output include a microphone 216 that provides a signal to the audio processor to provide a transmit voice signal as known, and conventional display, keypad, and optionally a SIM card reader. The transceiver, demodulator/decoder, transmit processing, and audio processing function are each inter-coupled, as depicted, to a controller 217 that provides overall operational command and control for the subscriber device. The controller 217 is coupled to and operates together with the display and keyboard or set of keys to effect a portion of a user interface and to facilitate development of a personalized audio profile. The keyboard can be a known physical keyboard or virtual keyboard that is part of the display and the display is also known and may be a liquid crystal display or the like. If the keys are part of a virtual keyboard the display will need to be touch sensitive or the like in order to convey information to the controller 217.

The controller 217 includes a processor 219 that is, preferably, a known micro-processor based element that is widely available and may include one or more micro processors and one or more digital signal processors depending on the precise responsibilities of the controller with respect to signaling duties that are not here relevant. The processor 219 may be coupled to a port not shown that allows an external device, such as a portable computer or the like to interface to the subscriber device and thus become, for example, a part of the user interface or a diagnostic and testing apparatus. In any event the processor 219 is also coupled to a memory 221 that may be a combination of known RAM, ROM, EEPROM or magnetic memory that among other items, such as messages and folders with messages, address books, standard or canned messages, and various operating variables and parameters 225 will store an operating software or system 223 for the processor. This operating software when executed by the processor will result in the processor performing the requisite functions of the subscriber device such as interfacing with the transceiver, display and keyboard, audio processing function 209 and so on including others that will be further described below. As depicted the memory further includes space for one or more profiles or personalized profiles corresponding to one or more specific users and a routine(s) that facilitate profile development 229 including preferably voiced menus and selection capabilities. The reader or one of ordinary skill will appreciate that this listing is merely a very brief listing of exemplary routines that will be required or advantageous in effecting a personalized audio profile and various command and control duties and that many others 231 including optional applications that may be stored in the memory have not been mentioned.

The audio processing function 209 is arranged and constructed and operates as the center of the processing that provides personalized audible signals for a user of the subscriber device. The audio processor includes an audio control block 233 that is coupled to the controller and operates to translate control signals corresponding to a particular profile or audio profile or user profile into signals that will result in a volume control or gain control 235 setting the proper volume or gain, a frequency response function 239 or filter setting the proper frequency response and in an energy distribution block 239 appropriately distributing or redistributing energy within a signal corresponding to an audible signal for the user that has been processed according to the profile, presumably for that user. These functions may be implemented as a programmable or semi-custom analog integrated circuit but it is preferred to use a digital signal processor for all or most of the processing. This processing may be combined with other processing such as would occur in the decoder using or sharing the same digital signal processor or other processing resources.

The volume control is straight forward and merely needs to be set according to a particular users profile as provided and interpreted initially by the controller 217 and thereafter by the audio control 233. The frequency response or filter, while depicted as a bandpass filter is more complex allowing for emphasis of low frequency or high frequency energy and optionally one or more energy bands within the signal, depending on the users profile. The energy distribution function allows for energy within one band to be converted to or redistributed to another band. This allows energy of the signal to be placed within a band where a user may have relatively better hearing thus effectively increasing the signal to noise ratio for the audible signal for that user. Other energy redistribution techniques include, for example, amplifying low level signals more than high level signals or essentially compressing the dynamic range of the signal. This can be useful since individuals with hearing disabilities often have lower dynamic range capabilities. With more elaborate processing, noise cancellation techniques can be utilized to increase signal to noise ratios for the user. Of course the compression and noise cancellation can be arranged to selectively occur in different frequency bands in order to aid those individuals with hearing impairments in certain bands. Certain of these techniques can be found in hearing aids.

Thus in essence the audio processing function includes a controller, such as controller 217 or audio control 233, for providing control signals that correspond to a user profile; an audio processor 209, coupled to the control signals and responsive thereto for providing a processed signal; and an output transducer 215 or earpiece, coupled to the processed signal or amplified version of the processed signal, for providing an audible signal corresponding to the processed signal and thus the user profile. The audio processing function or audio processor, responding to control signals, adjusts one or more of the volume, the frequency response, or the energy distribution of the processed signal. The profile or personalized audio profile or user profile is preferably developed by selecting, via the user input output device 213, for example keypad or a voice recognition application, a preferred characteristic from a plurality of characteristics.

One exemplary process is entering a menu for a characteristic, such as a frequency response, scrolling through and listening to a selection of voiced messages, each indicative of one possible frequency response until the message sounds best to the user and then selecting, thereby saving, that characteristic, here frequency response. This process is somewhat subjective and a hierarchical process of selecting various categories may be useful. For example you may want to have several intermediate selections that in the end result in a final selection for the preferred frequency response. For example “with” and “without” base or treble boost and if a boost is chosen then select from a few choices of how much. Different characteristics will entail different selection schemes. For example the volume setting may be straightforward for a given user and conditions. In any event the preferred characteristic, or here specifically the selected thus preferred frequency response, becomes part of the users profile along with other selections previously or subsequently made. This process will or may be repeated for additional characteristics in order to select a preferred volume, a preferred energy distribution of the audible signal, etc.

The resultant user profile, personalized according to the users selections is preferably stored in the memory of the controller at 227 or optionally written to a user ID card by the SIM card reader/writer. The profile could optionally also be stored together with other user/device information typically located at a home location or visitor location register with the service provider. The profile is stored and indexed to a numeric or alphanumeric string, such as “62” or “Bob” or “Bob 1” and when a user picks up the phone they can be assured of having the proper personalized profile by entering “62”, “Bob”, etc at the proper prompt. In one embodiment the subscriber device would provide for certain combinations of the various characteristics or a finite number of choices for the characteristics and thus finite number of unique profiles. This would provide the advantage that a user could pick up any subscriber device that was so equipped and by entering “62” at the proper prompt be assured of getting their personal audio profile. The selection process would be similar to the method described above but the subscriber unit would select the profile that most closely matched the users selections. In either case the user could have multiple profiles, “Bob 1” and “Bob 2”, for use in multiple environments, such as the home versus in the car or on the street corner with the additional noise. In addition to a likely difference in preferred volume one would expect that a given user would also want to change the frequency response or energy distribution in a noisier environment, perhaps forgoing some “naturalness” for “comprehension.”

Thus the subscriber device that is arranged and constructed to provide personalized audible signals to a user includes a controller 217, 233 for receiving a profile corresponding to the user; an audio processor or processing function 209, adapted according to the profile, for providing a processed signal; and a user output, the earpiece or speaker 215, coupled to the processed signal, for providing an audible signal corresponding to the processed signal and thus the profile or user profile. The user profile or profile or index corresponding thereto will be provided either by the user input output, keypad or SIM Card R/W, or possibly from the service provider when a call is initiated or received. The profile or information corresponding thereto is applied to the audio processor resulting in the audio processor being adapted according to the profile by adjusting one or more of a volume, a frequency response, or an energy distribution of the processed signal.

Note: this indicates that the profile is implemented only at the subscriber unit. If the service provider is aware of the personal profile information, such as when the subscriber unit via its included transceiver sends the profile to the service provider certain actions corresponding to the profile can be accomplished or undertaken at the service provider. For example, the audible signal can be one of voice messages or voiced menus that are presented to the user in a voice adjusted for compatibility with the profile. When these voice messages or menus originate with the service provider a masculine or feminine voice can be selected depending on a users preferences as reflected by the profile. For instance if the profile suggests that a higher pitched voice is preferred the service provider can select a feminine voice for there presentation.

As noted above the subscriber device includes one or more user input output devices (keyboard, display, SIM Card R/W, speaker and microphone) that may each or all be used for developing or facilitating development of the profile for the user. Preferably the subscriber device and specifically relevant user input output device used for developing the profile further includes means for selecting, such s the keypad, a preferred characteristic from a plurality of characteristics. Such preferred characteristics may include one or more of a preferred volume, a preferred frequency response, or a preferred energy distribution of the audible signal. The audible signal naturally is one of canned voice messages and voice communications signals and traffic.

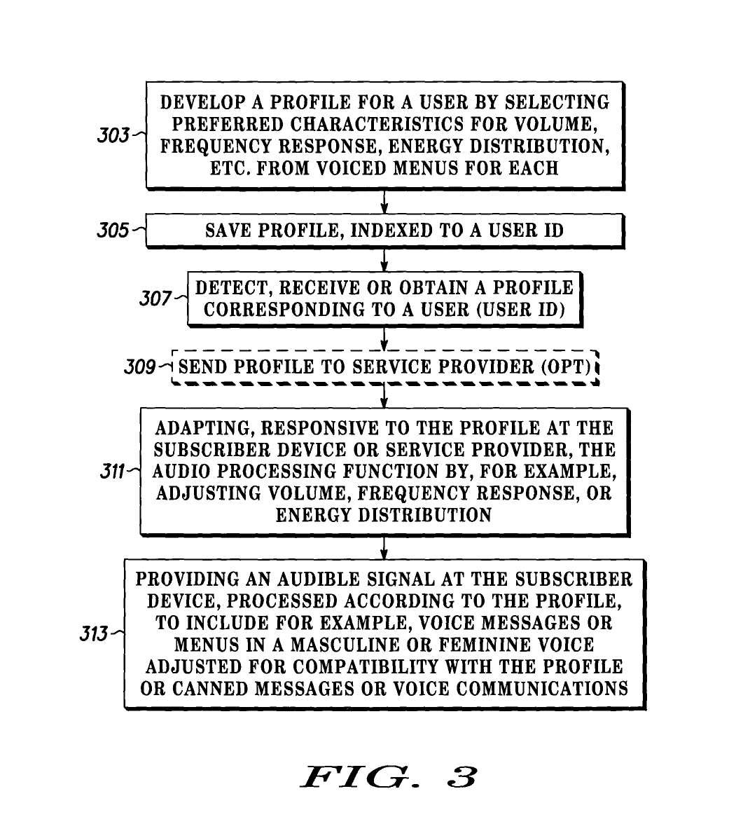

Referring to FIG. 3, a flow chart of a preferred method embodiment of providing a personalized audio profile for a user of a subscriber device will be reviewed and discussed. Much of this discussion will be in the nature of a review and summary of the discussions above. The method begins at 303 by developing one or more profiles for one or more users by selecting preferred characteristics from a plurality of corresponding such characteristics for each preferred characteristic. For example, selecting the preferred characteristic will include selecting one or more of a preferred volume, a preferred frequency response, or a preferred energy distribution of the audible signal. These profiles are then saved and indexed to a numeric or alpha-numeric user identification at either a subscriber device, on a SIM card or at the service provider 305. Next at 307 the method of providing a personalized audio profile for a user includes detecting, receiving, or otherwise obtaining at the subscriber device one of these profiles corresponding to the user. If the profile has been obtained from a local memory such as a SIM card or subscriber device memory, optional process 309, shows sending, responsive to the detecting, the profile to a service provider.

Thereafter 311 indicates that adapting, responsive to said profile, an audio processing function, preferably at the subscriber device but optionally at the service provider, by for example adjusting one or more of a volume, a frequency response, and an energy distribution of the audible signal. Next 313 shows providing an audible signal, at the subscriber device, that has been processed according to the profile to provide one or more of voice messages and voiced menus to the user in a voice adjusted for compatibility (male or female voice) with the profile or providing one of canned voice messages and voice communications.

The apparatus, processes, and personalized audio profile discussed above and the inventive principles thereof are intended to and will alleviate problems caused by prior art aural user interfaces. Using these principles of establishing a profile and processing audio signals according to the profile will facilitate audible user interfaces that are effective, efficient and friendly thus contributing to user satisfaction. It is expected that one of ordinary skill given the above described principles, concepts and examples will be able to implement other alternative procedures that are subscriber device dependent and that will also offer additional quick and efficient interface procedures for developing a profile. It is anticipated that the claims below cover such other examples.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of providing a personalized audio profile for a user of a subscriber device, the method comprising:
detecting at the subscriber device a profile corresponding to the user;
adapting, responsive to said profile, an audio processing function; and
providing an audible signal, at the subscriber device, that has been processed according to said profile.

2. The method of claim 1 wherein said adapting said audio processing function includes adapting said audio processing function at the subscriber unit.

3. The method of claim 1 wherein said adapting said audio processing function includes adapting said audio processing function at a service provider.

4. The method of claim 1 wherein said adapting said audio processing function further includes-adjusting one of a volume, a frequency response, and an energy distribution of said audible signal.

5. The method of claim 1 further including sending, responsive to said detecting, said profile to a service provider.

6. The method of claim 5 wherein said providing an audible signal further including providing one of voice messages and voiced menus to the user in a voice adjusted for compatibility with said profile.

7. The method of claim 1 further including developing said profile for the user.

8. The method of claim 7 wherein said developing said profile further includes selecting a preferred characteristic from a plurality of characteristics.

9. The method of claim 8 wherein said selecting said preferred characteristic further includes selecting one of a preferred volume, a preferred frequency response, and a preferred energy distribution of said audible signal.

10. The method of claim 1 wherein said providing said audible signal further includes providing one of canned voice messages and voice communications.

11. A subscriber device arranged and constructed to provide personalized audible signals to a user thereof, the subscriber device comprising:
a controller for receiving a profile corresponding to the user;
an audio processor, adapted according to said profile, for providing a processed signal; and
a user output, coupled to said processed signal, for providing an audible signal corresponding to said processed signal and thus said profile.

12. The subscriber device of claim 11 wherein said audio processor is adapted according to said profile by adjusting one of a volume, a frequency response, and an energy distribution of said processed signal.

13. The subscriber device of claim 11 further including a transceiver for sending, responsive to said receiving, said profile to a service provider.

14. The subscriber device of claim 13 wherein said user output for providing said audible signal further includes providing one of voice messages and voiced menus to the user in a voice adjusted for compatibility with said profile.

15. The subscriber device of claim 11 further including a user input output device for developing said profile for the user.

16. The subscriber device of claim 15 wherein said user input output device for developing said profile further includes means for selecting a preferred characteristic from a plurality of characteristics.

17. The subscriber device of claim 16 wherein said means for selecting said preferred characteristic further includes means for selecting one of a preferred volume, a preferred frequency response, and a preferred energy distribution of said audible signal.

18. The subscriber device of claim 11 wherein said user output for providing said audible signal further provides one of canned voice messages and voice communications.

19. An audio processing function arranged and constructed to provide personalized audible signals, the audio processor comprising:
a controller for providing control signals that correspond to a user profile;
an audio processor, coupled to the control signals and responsive thereto for providing a processed signal; and
an output transducer, coupled to said processed signal, for providing an audible signal corresponding to said processed signal and thus said user profile.

20. The audio processing function of claim 19 wherein said audio processor is responsive to said control signals to adjust one of a volume, a frequency response, and an energy distribution of said processed signal.

21. The audio processing function of claim 19 further including a user input output device for developing said user profile by selecting a preferred characteristic from a plurality of characteristics.

22. The audio processing function of claim 21 wherein said user input output device for developing said profile further selects one of a preferred volume, a preferred frequency response, and a preferred energy distribution of said audible signal.
